(19) United States
(12) Patent Application Publication
(10) Pub. No.: US 2007/0236574 A1
(43) Pub. Date: Oct. 11, 2007

(54) DIGITAL FILTERING WITH NOISE GAIN LIMIT

(75) Inventors: Alex Alon, Binyamina (IL); Irina Alon, Binyamina (IL)

Correspondence Address: DARBY & DARBY P.C., P.O. BOX 770, Church Street Station, New York, NY, 10008-0770, US

(73) Assignee: D-BLUR TECHNOLOGIES LTD., Herzlia Pituach (IL)

(21) Appl. No.: 11/278,268

(22) Filed: Mar. 31, 2006

(51) Int. Cl. H04N 5/225

(52) U.S. Cl. 348/207.99

(57) ABSTRACT

A method for producing a camera, which includes objective optics for forming an image on an electronic image sensor and a digital filter for filtering an output of the image sensor. The method includes defining a maximum permissible value of a noise gain and determining one or more aberrations due to the objective optics. Coefficients of the digital filter are calculated so as to compensate for the one or more aberrations while preventing the noise gain of the digital filter from exceeding the maximum permissible value. The output of the image sensor is filtered using the computed coefficients so as to generate an enhanced output image.

### CROSS-REFERENCE TO RELATED APPLICATIONS

This application is related to two U.S. patent applications, filed on even date, entitled “Combined Design of Optical and Image Processing Elements,” and “Camera Performance Simulation.” These related applications are assigned to the assignee of the present patent application, and their disclosures are incorporated herein by reference.

### FIELD OF THE INVENTION

The present invention relates generally to digital imaging, and specifically to methods for designing digital cameras with enhanced image quality, as well as operation of cameras produced by such methods.

### BACKGROUND OF THE INVENTION

The objective optics used in digital cameras are typically designed so as to minimize the optical point spread function (PSF) and maximize the modulation transfer function (MTF), subject to the limitations of size, cost, aperture size, and other factors imposed by the camera manufacturer. The PSF of the resulting optical system may still vary from the ideal due to focal variations and aberrations. A number of methods are known in the art for measuring and compensating for such PSF deviations by digital image processing. For example, U.S. Pat. No. 6,154,574, whose disclosure is incorporated herein by reference, describes a method for digitally focusing an out-of-focus image in an image processing system. A mean step response is obtained by dividing a defocused image into sub-images, and calculating step responses with respect to the edge direction in each sub-image. The mean step response is used in calculating PSF coefficients, which are applied in turn to determine an image restoration transfer function. An in-focus image is obtained by multiplying this function by the out-of-focus image in the frequency domain.

As another example, U.S. Pat. No. 6,567,570, whose disclosure is incorporated herein by reference, describes an image scanner, which uses targets within the scanner to make internal measurements of the PSF. These measurements are used in computing convolution kernels, which are applied to images captured by the scanner in order to partially compensate for imperfections of the scanner lens system.

It is also possible to add a special-purpose blur to an image so as to create invariance to certain optical aberrations. Signal processing is then used to remove the blur. A technique of this sort is described by Kubala et al., in “Reducing Complexity in Computational Imaging Systems,” Optics Express 11 (2003), pages 2102-2108, which is incorporated herein by reference. The authors refer to this technique as “Wavefront Coding.” A special aspheric optical element is used to create the blur in the image. This optical element may be a separate stand-alone element, or it may be integrated into one or more of the lenses in the optical system. Optical designs and methods of image processing based on Wavefront Coding of this sort are described, for example, in U.S. Pat. No. 5,748,371 and in U.S. Patent Application Publications US 2002/0118457 A1, US 2003/0057353 A1 and US 2003/0169944 A1, whose disclosures are incorporated herein by reference.

PCT International Publication WO 2004/063989 A2, whose disclosure is incorporated herein by reference, describes an electronic imaging camera, comprising an image sensing array and an image processor, which applies a deblurring function—typically in the form of a deconvolution filter—to the signal output by the array in order to generate an output image with reduced blur. This blur reduction makes it possible to design and use camera optics with a poor inherent PSF, while restoring the electronic image generated by the sensing array to give an acceptable output image. The optics are designed by an iterative process, which takes into account the deblurring capabilities of the camera. For this purpose, an initial optical design is generated, and the PSF of the design is calculated based on the aberrations and tolerances of the optical design. A representative digital image, characterized by this PSF, is computed, and a deblurring function is determined in order to enhance the PSF of the image, i.e., to reduce the extent of the PSF. The design of the optical system is then modified so as to reduce the extent of the enhanced PSF. This process is said to optimize the overall performance of the camera, while permitting the use of low-cost optics with relatively high manufacturing tolerances and a reduced number of optical elements.

### SUMMARY OF THE INVENTION

Embodiments of the present invention provide improved methods and tools for design of digital cameras with digital deblurring capabilities. Cameras used in these embodiments typically comprise a digital filter, such as a deconvolution filter (DCF), which is used to reduce blur in the digital output image.

In some embodiments, in the course of the design of the camera, the filter is treated as though it were one of the optical elements in the objective optics of the camera. This approach permits the design specifications of the objective optics themselves (in terms of PSF and/or MTF, for example) to be relaxed, thus giving the optical designer greater freedom in choosing the lens parameters for the actual objective optics.

Following the initial design of the objective optics, the filter parameters are computed so as to provide an output image that comes as close as possible to meeting the design specifications of the camera, within constraints that may be imposed on the DCF. For example, in some embodiments, the DCF kernel values are constrained so as to limit the noise gain that often arises when an image is digitally sharpened. A design tool computes the output image quality based on the parameters of the optical design and the filter. Optionally, the tool may compute and display a simulated image based on these parameters, in order to enable the designer to see the effect of the chosen parameters.

In some cases, it may be determined that the initially-computed DCF, taken together with the initial optical design, does not provide the required output image quality or fails to meet other requirements of the camera specifications. (Reasons for not meeting requirements may include noise gain limitations, PSF variations, or limitations on the size of the DCF kernel, for example.) In such cases, in some embodiments of the present invention, the process of optical design and filter computation is repeated iteratively until the camera specifications are satisfied.

There is therefore provided, in accordance with an embodiment of the present invention, a method for producing a camera, which includes objective optics for forming an image on an electronic image sensor and a digital filter for filtering an output of the image sensor, the method including:

defining a maximum permissible value of a noise gain;

determining one or more aberrations due to the objective optics;

calculating coefficients of the digital filter so as to compensate for the one or more aberrations while preventing the noise gain of the digital filter from exceeding the maximum permissible value; and

filtering the output of the image sensor using the computed coefficients so as to generate an enhanced output image.

In a disclosed embodiment, determining the one or more aberrations includes computing a point spread function (PSF) of the objective optics, and calculating the coefficients includes computing a kernel of a deconvolution filter (DCF) responsively to the PSF.

Typically, defining the maximum permissible value of the noise gain includes determining the maximum permissible value responsively to a noise characteristic of the image sensor.

In one embodiment, filtering the output includes smoothing the output, and defining the maximum permissible value of the noise gain includes determining the maximum permissible value subject to the smoothing. Smoothing the output may include identifying edges in the output image, and applying a low-pass filter to areas of the output image other than the edges.

In a disclosed embodiment, calculating the coefficients includes estimating a modulation transfer function (MTF) of the objective optics responsively to the noise gain, and determining the coefficients so as to enhance the MTF.

There is also provided, in accordance with an embodiment of the present invention, a computer software product for producing a camera, which includes objective optics for forming an image on an electronic image sensor and a digital filter for filtering an output of the image sensor, the product including a computer-readable medium in which program instructions are stored, which instructions, when read by a computer, cause the computer to receive a definition of a maximum permissible value of a noise gain and an indication of one or more aberrations due to the objective optics, and to calculate coefficients of the digital filter so as to compensate for the one or more aberrations while preventing the noise gain of the digital filter from exceeding the maximum permissible value.

There is additionally provided, in accordance with an embodiment of the present invention, apparatus for producing a camera, which includes objective optics for forming an image on an electronic image sensor and a digital filter for filtering an output of the image sensor, the apparatus including:

means for defining a maximum permissible value of a noise gain;

means for determining one or more aberrations due to the objective optics; and

means for calculating coefficients of the digital filter so as to compensate for the one or more aberrations while preventing the noise gain of the digital filter from exceeding the maximum permissible value.

There is further provided, in accordance with an embodiment of the present invention, an electronic imaging camera, including:

an electronic image sensor;

objective optics for forming an image on an electronic image sensor; and

a digital filter for filtering an output of the image sensor,

wherein coefficients of the digital filter are calculated responsively to a maximum permissible value of a noise gain so as to compensate for one or more aberrations of the objective optics while preventing the noise gain of the digital filter from exceeding the maximum permissible value.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a digital camera, in accordance with an embodiment of the present invention;

FIG. 2 is a schematic, pictorial illustration of a system for designing a digital camera, in accordance with an embodiment of the present invention;

FIG. 3A is a schematic, pictorial illustration showing conceptual elements of a digital camera used in a design process, in accordance with an embodiment of the present invention;

FIG. 3B is a plot of modulation transfer functions (MTF) for a digital camera with and without application of a deconvolution filter, in accordance with an embodiment of the present invention;

FIG. 4 is a flow chart that schematically illustrates a method for designing a digital camera, in accordance with an embodiment of the present invention;

FIGS. 5A-5C are schematic, isometric plots of DCF kernels used in a digital camera, in accordance with an embodiment of the present invention;

FIG. 6 is an image that simulates the output of an image sensor using objective optics with specifications that have been relaxed in accordance with an embodiment of the present invention; and

FIG. 7 is an image that simulates the effect of application of an appropriate DCF to the image of FIG. 6, in accordance with an embodiment of the present invention.

### DETAILED DESCRIPTION OF EMBODIMENTS

### Definitions

The following is a non-exhaustive list of technical terms that are used in the present patent application and in the claims. Although these terms are used herein in accordance with the plain meaning accorded the terms in the art, they are listed below for the convenience of the reader in understanding the following description and the claims.
Pitch of a detector array refers to the center-to-center distance between elements of the array.
Cylindrical symmetry describes a structure, such as a simple or compound lens, which has an optical axis such that the structure is invariant under rotation about the optical axis for any and all angles of rotation.
Point spread function (PSF) is the impulse response of an optical system in the spatial domain, i.e., the image formed by the system of a bright point object against a dark background.
Extent of the PSF is the full width at half maximum (FWHM) of the PSF.
Optical transfer function (OTF) is the two-dimensional Fourier transform of the PSF to the frequency domain. Because of the ease with which a PSF may be transformed into an OTF, and vice versa, computation of the OTF is considered to be equivalent to computation of the PSF for the purposes of the present invention.
Modulation transfer function (MTF) is the modulus of the OTF.
Optical radiation refers to electromagnetic radiation in any of the visible, infrared and ultraviolet regions of the spectrum.

### System Overview

FIG. 1 is a block diagram that schematically illustrates a digital camera 20, in accordance with an embodiment of the present invention. The camera comprises objective optics 22, which focus an image onto an image sensor 24. Optics 22 are designed in an iterative process together with a deconvolution engine 26 that operates on image data that are output by image sensor 24. The deconvolution engine applies one or more digital filters, typically comprising at least one deconvolution filter (DCF), to the image data. The design process and method of filtering are described in detail hereinbelow. The DCF kernel is typically chosen so as to correct for blur in the image formed by optics 22. After filtering, the image data are processed by an image signal processor (ISP) 28, which performs standard functions such as color balance and format conversion and outputs the resulting image.

The optical and digital processing schemes illustrated in FIG. 1 are shown here solely for the sake of example, as an aid to understanding the techniques and tools that are described hereinbelow. In practice, the principles of the present invention may be applied in conjunction with a wide variety of electronic imaging systems, using substantially any sort of optical design and substantially any type of image sensor, including both two-dimensional detector matrices and linear detector arrays, as are known in the art. Deconvolution engine 26 and ISP 28 may be implemented as separate devices or as a single integrated circuit component. In either case, the deconvolution engine and ISP are typically combined with other I/O and processing elements, as are known in the art. In the context of the present patent application, the term “digital camera” should therefore be understood as referring to any and all sorts of electronic imaging systems that comprise an image sensor, objective optics for focusing optical radiation onto the image sensor, and electronic circuits for processing the sensor output.

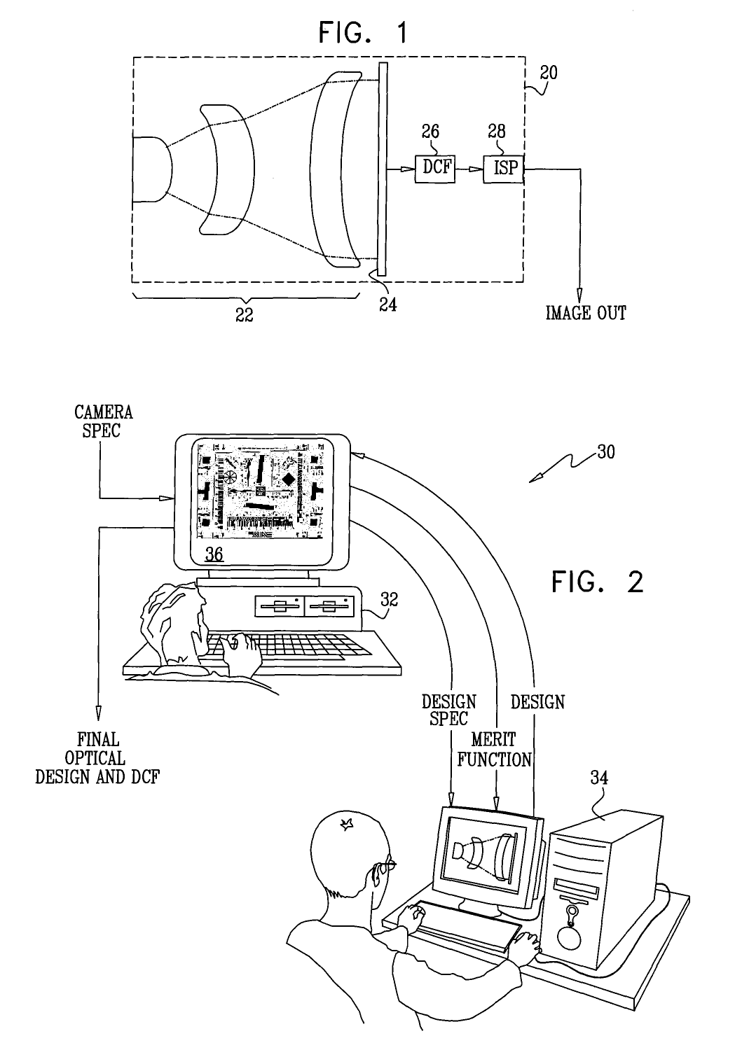

FIG. 2 is a schematic, pictorial illustration showing a system 30 for designing a digital camera, in accordance with an embodiment of the present invention. System comprises a digital processing design station 32 and an optical design station 34. Processing design station 32 receives a camera specification as input, from a camera manufacturer, for example, specifying the key dimensions, sensor type and desired optical characteristics (referred to hereinafter as the target optical specification) of the camera. The specified optical characteristics may include, for example, the number of optical elements, materials, tolerances, focal length, magnification, aperture (F-number), depth of field, and resolution performance. The optical resolution performance is typically defined in terms of the MTF, but it may alternatively be specified in terms of PSF, wavefront quality, aberrations, and/or other measures of optical and image quality that are known in the art.

Processing design station 32 analyzes and modifies the target optical specification, taking into account the expected operation of engine 26, in order to provide a modified optical specification to the optical design station. Typically, both the original camera specification and the modified optical specification use cylindrically-symmetrical optical elements. Specialized phase plates or other elements that break the cylindrical symmetry of the optics are generally undesirable, due to their added cost, and engine 26 is able to correct the aberrations of optics 22 without requiring the use of such elements. In addition, processing design station 32 may compute and provide to optical design station 34 a merit function, indicating target values of the aberrations of optics 22 or scoring coefficients to be used in weighting the aberrations in the course of optimizing the optical design. The aberrations express deviations of the optical wavefront created by optics 22 from the ideal, and may be expressed, for example, in terms of Zernike polynomials or any other convenient mathematical representation of the wavefront that is known in the art.

Optical design station 34 is typically operated by a lens designer, in order to produce a lens design according to the modified optical specification provided by processing design station 32. The processing design station determines the optimal DCF (and possibly other filters) to be used in engine 26 in conjunction with this lens design. The DCF computation is tied to the specific lens design in question so that the filter coefficients reflect the “true” PSF of the actual optical system with which the DCF is to be used.

The processing design station then evaluates the optical design together with the DCF in order to assess the combined result of the expected optical quality of optics 22 and the enhancement expected from engine 26, and to compare the result to the target optical specification. The assessment may take the form of mathematical analysis, resulting in a quality score. A quality scoring schemes that may be used in this context is described hereinbelow. Alternatively, other quality scoring schemes may be used, such as that described, for example, in the above-mentioned PCT publication WO 2004/063989 A2. Alternatively or additionally, station 32 may generate and display a simulated image 36, which visually demonstrates the output image to be expected from the camera under design based on the current choice of optical specifications and DCF.

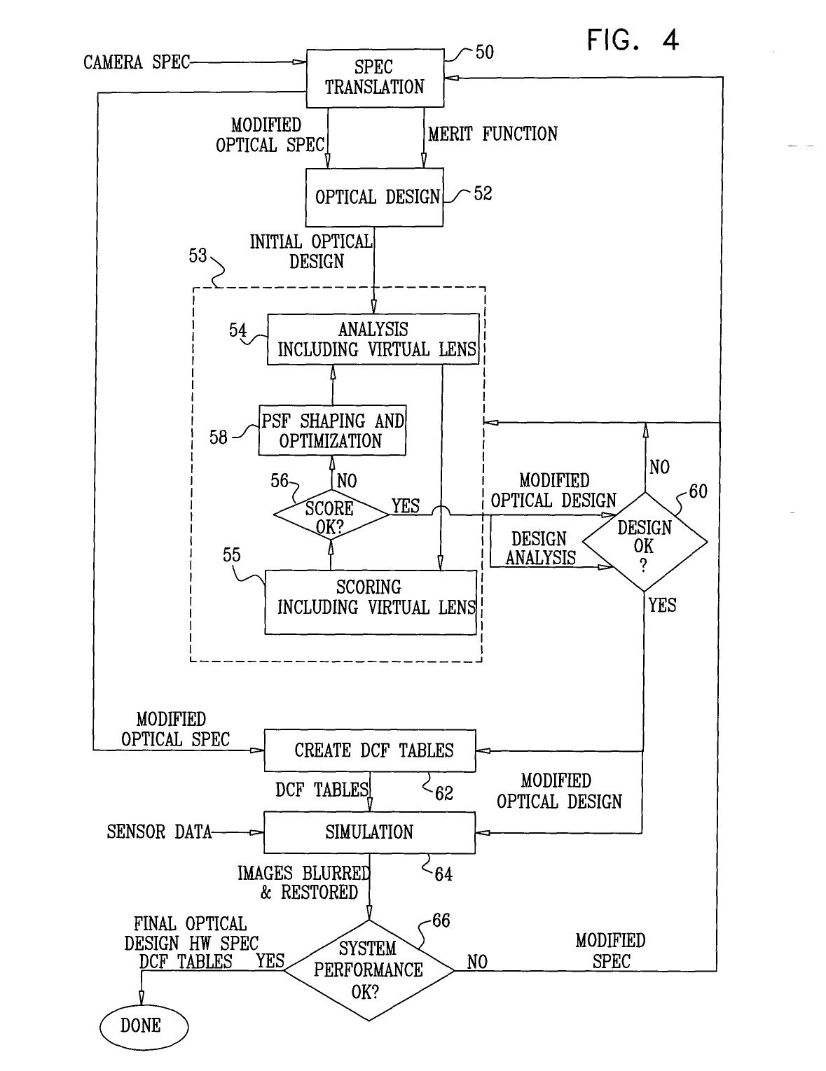

If the result of the analysis by station 32 indicates that the combined optical and DCF design will meet the target specifications, then the complete camera design, including optics and DCF, is output for production. Otherwise, the processing design station may perform further design iterations internally, or it may generate a further modified optical specification, which it passes to optical design station 34 for generation of a modified optical design. This process may continue iteratively until a suitable optical design and DCF are found. Details of this process are described hereinbelow with reference to FIG. 4.

Typically, stations 32 and 34 comprise general-purpose computers running suitable software to carry out the functions described herein. The software may be downloaded to the computers in electronic form, over a network, for example, or it may alternatively be furnished on tangible media, such as optical, magnetic, or electronic memory media. Alternatively, some of the functions of stations 32 and/or 34 may be implemented using dedicated or programmable hardware components. The functions of optical design station 34 may be carried out using off-shelf optical design software, such as ZEMAX® (produced by ZEMAX Development Corp., San Diego, Calif.). Although stations 32 and 34 are shown and described, for the sake of conceptual clarity, as separate computer workstations, the functions of these stations may alternatively be combined in a single physical machine, running software processes for both optical design and digital processing design.

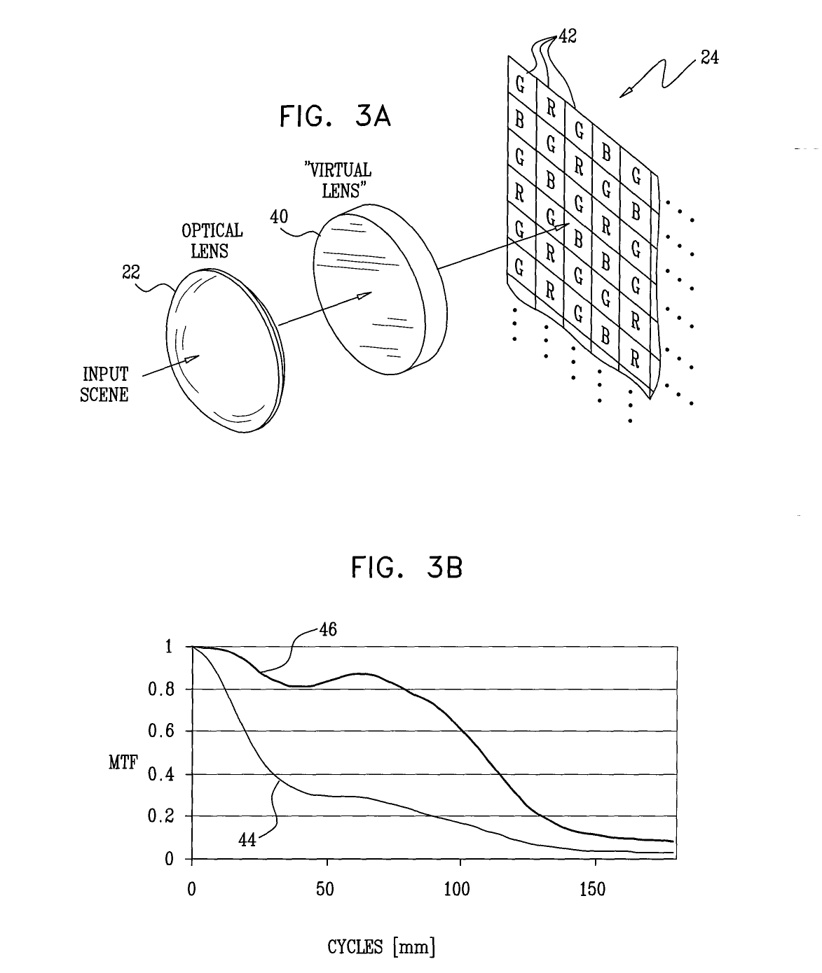

FIG. 3A is a schematic, pictorial illustration showing conceptual elements of camera 20, as they are applied in the design process used in system 30, in accordance with an embodiment of the present invention. System 30 takes engine 26 into account in the design of optics 22, as explained hereinabove, and thus relates to the DCF as a sort of “virtual lens” 40. In other words, the design constraints on the actual objective optics are relaxed by the use of this virtual lens, as though the optical designer had an additional optical element to incorporate in the design for purposes of aberration correction. The virtual lens that is implemented in engine 26 is chosen, in conjunction with the actual optical lenses, to give an image output that meets the manufacturer's camera specifications.

FIG. 3B is a plot showing the MTF of a camera designed using system 30, in accordance with an embodiment of the present invention. The plot includes an uncorrected curve 44, corresponding to the modified optical specification generated by station 32 for use in designing optics 22 on station 34. The low MTF permitted by curve 44 is indicative of the expected improvement in MTF that can be achieved by use of DCF 26. A corrected curve 46 shows the net MTF of the camera that is achieved by applying the DCF to the image sensor output. These curves show the MTF at the center of the optical field, with the object at a certain distance from the camera. In practice, the MTF may be specified at multiple different focal depths and field angles.

The design concept exemplified by FIGS. 3A and 3B permits the camera manufacturer to achieve the desired level of optical performance with fewer, smaller and/or simpler optical components than would be required to achieve the same result by optical means alone. Additionally or alternatively, the camera may be designed for enhanced performance, such as reduced aberrations, reduced F-number, wide angle, macro operation, or increased depth of field.

### Detailed Design Process

FIG. 4 is a flow chart that schematically illustrates a method for designing a digital camera, in accordance with an embodiment of the present invention. The method will be described hereinbelow, for the sake of clarity, with reference to camera 20 and system 30, although the principles of this method may be applied generally to other cameras and using other design systems.

The point of departure of the design is the camera specification, as noted above. Processing design station 32 translates the target optical specification of the camera into a modified optical specification, at a specification translation step 50. For this purpose, station 32 uses an estimate of the DCF to be implemented in the camera. The image enhancement to be expected due to this DCF is then applied to the optical specification in order to estimate how far the optical design parameters, such as the MTF, can be relaxed.

Image enhancement by the DCF, however, tends to amplify noise in the output of image sensor 24. Generally speaking, the noise gain NG is proportional to the norm of the DCF (\sqrt{D^{t}D}, wherein D is the DCF kernel and the superscript t indicates the Hermitian transpose). Therefore, in estimating the DCF, and hence in estimating the degree to which the optical design parameters can be relaxed, the processing design station uses the maximum permissible noise gain as a limiting condition. Typically, engine 26 may also comprise a noise filter. The limit placed on the DCF coefficients by the noise gain may thus be mitigated by the noise reduction that is expected due to the noise filter. In other words, the norm of the DCF kernel is approximately given by the product of the maximum permissible noise gain with the expected noise reduction factor (i.e., the ratio of image noise following the noise filter to image noise without noise filtering). Alternatively, a more accurate estimate of the overall noise gain may be obtained by taking the norm of the product of the noise filter multiplied by the DCF in the frequency domain.

In order to determine the noise gain and permissible MTF reduction, the OTF may be assumed, at first approximation, to be linear as a function of spatial frequency q, which is normalized to the Nyquist frequency of image sensor 24:
OTF=1−λq }q≦1/λ
OTF=0 }q>1/λ (1)
The PSF may be determined analytically from the OTF of equation (1). Because of the zeroes in the OTF, the frequency-domain representation of the DCF to be used in the camera may be estimated as:

$$DCF = \frac{OTF}{{OTF}^{2} + {α}^{2}} \qquad ( 2 )$$

wherein α is a small number that keeps the DCF from exploding for small PSF.

The noise gain NG due to the DCF of equation (2) depends on the two parameters λ, α:

$${( NG )}^{2} = \frac{π}{{λ}^{2}} [ \frac{arctan ( 1 / α )}{α} - ln ( \frac{1}{{α}^{2}} + 1 ) ] \qquad ( 3 )$$

These parameters are chosen so that the noise gain does not exceed a target bound, for example, 300%. If the original camera specifications include a noise figure, the maximal permissible noise gain may be determined by comparing the expected noise characteristic of image sensor 24 to the noise specification. As noted above, digital smoothing of the noise in the output image may also be taken into account in order to permit the constraint on noise gain in the DCF to be relaxed.

Various noise removal methods, as are known in the art, may be used in engine 26. For example, a morphological operation may be used to identify edges in the image, followed by low-pass filtering of non-edge areas. The choice of noise removal method to be used in engine 26, however, is beyond the scope of the present invention.

Having chosen appropriate values of the parameters, the average MTF over the normalized frequency range [0,1] is given by:

$${MTF}_{avg} = \frac{1}{λ} ( 1 - α * arctan ( 1 / α ) ) \qquad ( 4 )$$

The formulas given above in equations (3) and (4) apply for λ>1, which will be the case in most simple camera designs. Alternative estimates may be developed for high-resolution cameras in which λ<1. For α<<1, the noise gain may be expressed as a polynomial series in α or in the form:

$${NG}^{2} = \frac{π}{{λ}^{2}} ( \frac{{π}^{2}}{4 ( 1 - λ * {MTF}_{avg} )} - 2 ln ( \frac{π}{2 ( 1 - λ * {MTF}_{avg} )} ) ) \qquad ( 5 )$$

Other representations will be apparent to those skilled in the art.

Equations (4) and (5) may be used in estimating how far the MTF of optics 22 may be reduced relative to the original target specification, subject to a given noise gain limit. This reduction factor may be applied, for example, to the MTF required by the original camera specification at a benchmark frequency, such as half the Nyquist frequency. In the example shown in FIG. 3B, the target MTF has been reduced to about ⅓ of its original specified value. The MTF will be restored in the output image from camera 20 by operation of the DCF in engine 26.

Referring back now to FIG. 4, processing design station 32 may also generate a merit function at step 50 for use by the optical designer. The merit function may take the form of aberration scores, which are assigned to each significant aberration that may characterize optics 22. For this purpose, the aberrations may be expressed, for example, in terms of the Zernike polynomials, for each of the colors red, green and blue individually. Standard software packages for optical design, such as ZEMAX, are capable of computing the Zernike polynomial coefficients for substantially any design that they generate. Values of the merit functions may be provided in tabular form. Generation of these values is described in detail in the above-mentioned PCT Publication WO 2004/063989 A2.

Alternatively or additionally, processing design station 32 may generate target wavefront characteristics that the optical design should achieve in the image plane (i.e., the plane of sensor 24). These wavefront characteristics may conveniently be expressed in terms of values of the aberrations of optics 22, such as Zernike coefficient values. Typically, aberrations that can be corrected satisfactorily by deconvolution engine 26 may have high values in the optical design, whereas aberrations that are difficult to correct should have low values. In other words, an aberration that would have a high score in the merit function will have a low target value, and vice versa. The target aberration values can be seen as the inverse of the wavefront corrections that can be achieved by “virtual lens” 40. The target aberration values may also include aberrations that reduce the sensitivity of the optics to various undesirable parameters, such as manufacturing deviations and defocus.

An optical designer working on station 34 uses the specification, along with the merit function and/or aberration target values provided at step 50, in generating an initial design of optics 22, at an optical design step 52. The designer may use the merit function in determining a design score, which indicates how to trade off one aberration against another in order to generate an initial design that maximizes the total of the merit scores subject to the optical specification. Additionally or alternatively, the optical designer may insert a dummy optical element, with fixed phase characteristics given by the target aberration values as an additional element in the optical design. This dummy optical element expresses the wavefront correction that is expected to be achieved using engine 26 and thus facilitates convergence of the calculations made by the optical design software on station 34 to the desired design of the elements of optics 22.

Control of the design process now passes to processing design station 32, in a design optimization stage 53. The processing design station analyzes the optical design, at a design analysis step 54. The analysis at this step may include the effect of virtual lens 40. At step 54, station 32 typically computes the optical performance of the optics as a function of wavelength and of location in the image plane. For example, station 32 may perform an accurate ray trace computation based on the initial optical design in or to calculate a phase model at the image plane, which may be expressed in terms of Zernike polynomial coefficients. The total aberration—and hence the PSF—at any point in the image plane may be obtained from the total wavefront aberration, which is calculated by summing the values of the Zernike polynomials.

Station 32 determines a design quality score, at a scoring step 55. Typically, this score combines the effects of the PSF on image resolution and on artifacts in the image, and reflects the ability of engine 26 to compensate for these effects. The score measures the extent to which the current optical design, taken together with filtering by engine 26, will satisfy the camera specification that was originally provided as input to station 32 as input to step 50.

In an exemplary embodiment, the score computed at step 55 is based on the camera specification and on a set of weights assigned to each parameter in the camera specification. The camera specification is expressed in a list of desired parameter values at various image plane locations and wavelengths, such as:
MTF
Geometrical distortion
Field of view
Chromatic aberrations
Chief ray angle
F-number
Relative illumination
Artifact level
Glare
Back focal length
Manufacturing tolerances
Depth of field
Noise level
Total length of optics.
   The weight assigned to each parameter is typically determined by its scaling, subjective importance, and likelihood of satisfying the desired parameter value relative to other parameters.

The overall score is computed by summing the weighted contributions of all the relevant parameters. In this embodiment, if a given parameter is within the specified range, it makes no contribution to the score. If the value is outside the specified range, the score is decreased by the square difference between the parameter value and the closest permissible value within the specified range, multiplied by the appropriate weight. A design that fully complies with the camera specification will thus yield a zero score, while non-compliance will yield negative values. Alternatively, other parameters and other methods may be used in computing numerical values representing how well the current design satisfies the camera specification.

The score computed at step 55 is assessed to determine whether it indicates that the current design is acceptable, at a quantitative assessment step 56. If the design does not meet the specification, station 32 modifies the optical design parameters at an optimization step 58. For this purpose, the station may estimate the effects of small changes in the aberrations on the PSF. This operation gives a multi-dimensional gradient, which is used in computing a change to be made in the optical design parameters by linear approximation. The DCF parameters may be adjusted accordingly. A method for computing and using gradients of this sort is described, for example, in the above-mentioned PCT Publication WO 2004/063989 A2. The results of step 58 are input to step 54 for recomputation of the optical performance analysis. The process continues iteratively through steps 55 and 56 until the design quality score reaches a satisfactory result.

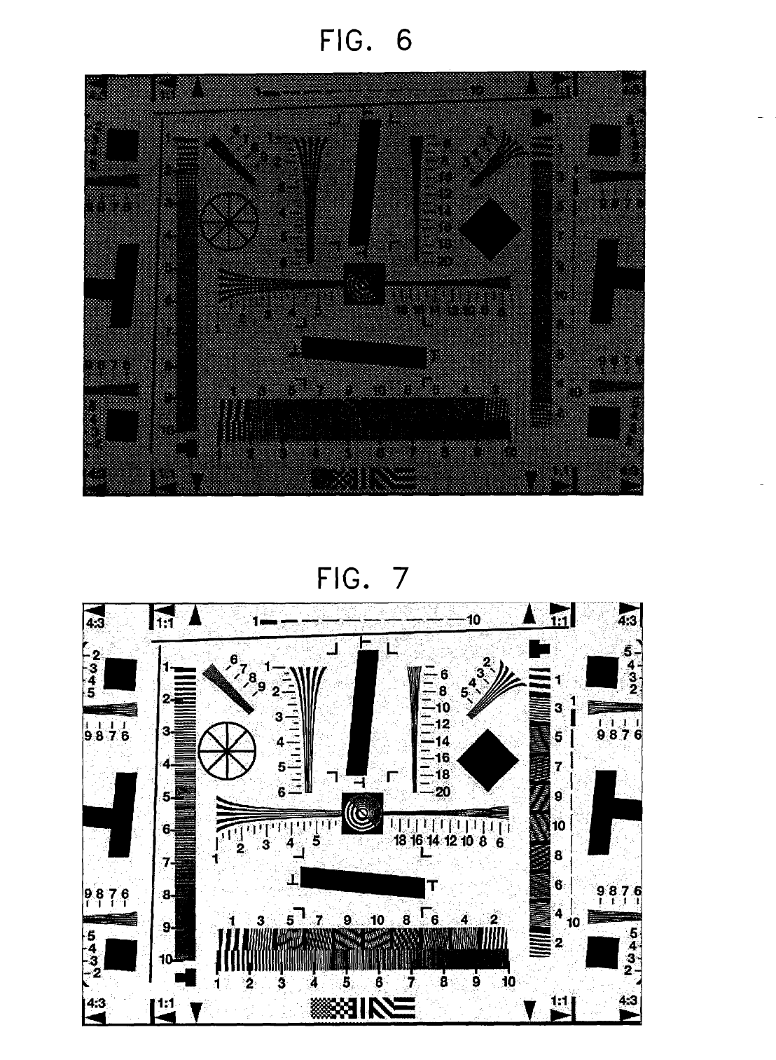

Once the design has converged, the design parameters are presented by processing design station 32 to the system operator; at a design checking step 60. Typically, the system operator reviews the optical design (as modified by station 32 in step 58, if necessary), along with the results of the design analysis performed at step 54. Additionally or alternatively, the optical design and DCF may be used at this point in generating a simulated output image, representing the expected performance of the camera in imaging a known scene or test pattern. (Exemplary simulated images of this sort are shown below in FIGS. 6 and 7.) The system operator reviews the design in order to verify that the results are indeed satisfactory for use in manufacture of camera 20. If not, the operator may change certain parameters, such as specification parameters and/or scoring weights, and return to stage 53. Alternatively, if it appears that there are serious problems with the design, the operator may initiate changes to the original camera specification and return the process to step 50. This sort of operator involvement may also be called for if stage 53 fails to converge to an acceptable score at step 56.

Once the design is found to be acceptable, processing design station 32 generates tables of values to be used in camera 20, at a DCF creation step 62. Typically, because of the non-uniform performance of optics 22, the DCF tables vary according to location in the image plane. In an exemplary embodiment, a different DCF kernel is computed for each region of 50×50 pixels in image sensor 24.

Furthermore, when sensor 24 is a color image sensor, different kernels are computed for the different color planes of sensor 24. For example, referring back to FIG. 3A, common mosaic image sensors may use a Bayer pattern of red, green, and blue pixels 42. In this case, the output of the image sensor is an interleaved stream of sub-images, comprising pixel samples belonging to different, respective colors. DCF 26 applies different kernels in alternation, so that the pixels of each color are filtered using values of other nearby pixels of the same color. Appropriate kernel arrangements for performing this sort of filtering are described in U.S. Provisional Patent Application. 60/735,519, filed Nov. 10, 2005, which is assigned to the assignee of the present patent application and is incorporated herein by reference.

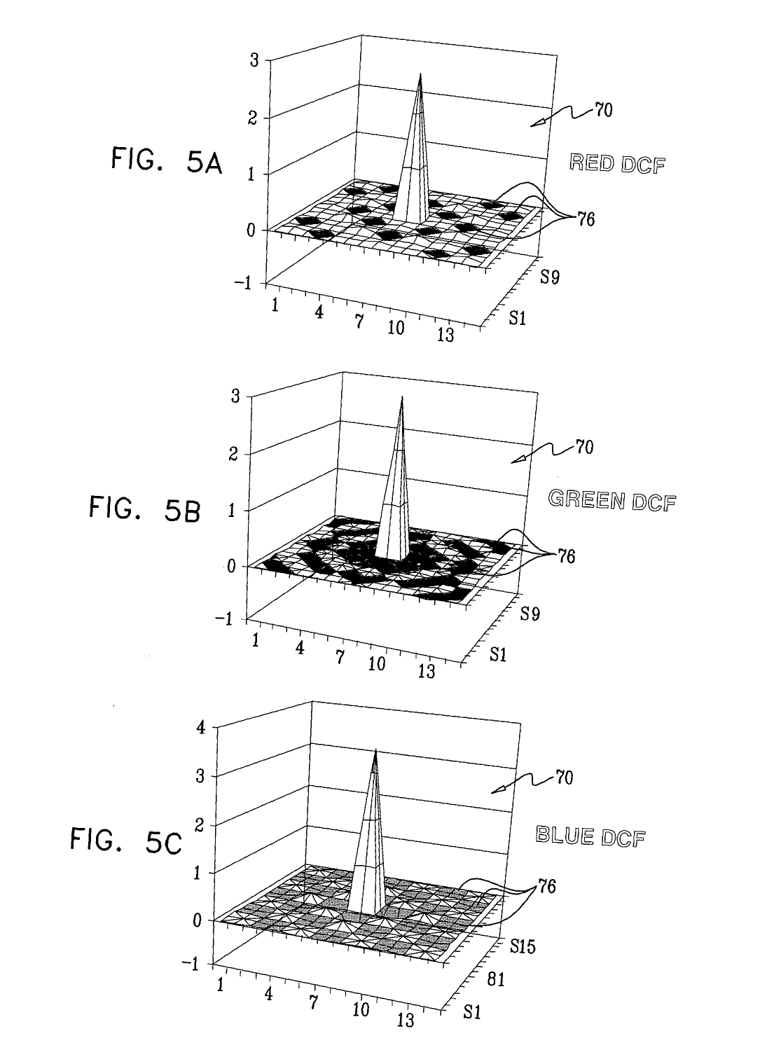

FIGS. 5A, 5B and 5C are schematic, isometric plots of DCF kernels 70, 72 and 74 for red, green, and blue pixels, respectively, which are computed in accordance with an embodiment of the present invention. Each kernel extends over 15×15 pixels, but contains non-zero values only at pixels of the appropriate color. In other words, in red kernel 70, for example, in each square of four pixels, only one—the red pixel—has a non-zero value. Blue kernel 74 is similarly constructed, while green kernel 72 contains two non-zero values in each four-pixel square, corresponding to the greater density of green pixels in the Bayer matrix. In each kernel, the central pixel has a large positive value, while surrounding values are lower and may include negative values 76. As explained above, the DCF values are chosen so that the norm does not exceed the permitted noise gain.

Referring back to FIG. 4, design station 32 uses the DCF tables from step 62 and the optical design output from stage 53 in simulating the performance of camera 20, at a simulation step 64. The simulation may also use characteristics, such as noise figures, of image sensor 24 that is to be installed in the camera, as well as other factors, such as manufacturing tolerances to be applied in producing the camera and/or operation of ISP 28. The results of this step may include simulated images, like image 36 (FIG. 2), which enable the system operator to visualize the expected camera performance.

FIGS. 6 and 7 are images that simulate the expected output of camera 20, as may be generated at step 64, in accordance with an embodiment of the present invention. FIG. 6 shows a standard test pattern as it would be imaged by optics and captured by image sensor 24, without the use of DCF 26. The image of the test pattern is blurred, especially at higher spatial frequencies, due to the low MTF of camera 20. (The MTF is given roughly by uncorrected curve 44 in FIG. 3B.) In addition, the image pixels are decimated due to the use of a color mosaic sensor, and random noise is added to the image corresponding to the expected noise characteristics of the image sensor.

FIG. 7 shows the image of FIG. 6 after simulation of processing by DCF 26, including noise removal as described hereinbelow. The MTF of this image is given roughly by curve 46 in FIG. 3B. (The aliasing apparent in the images of the high-frequency test patterns is the result of a true simulation of the performance of a low-resolution image sensor following DCF processing.) The system operator, viewing this image, is able to ascertain visually whether the camera performance will meet the original camera specifications that were provided at step 50.

The system operator's visual assessment is combined with the numerical results of the design analysis, in order to determine whether the overall performance of the design is acceptable, at an acceptance step 66. If there are still flaws in the simulated image or in other design quality measures, the design iteration through stage is repeated, as described above. Alternatively, in case of serious flaws, the camera specification may be modified, and the process may return to step 50. Otherwise, system 30 outputs the final optical design and DCF tables, together with other aspects of the hardware circuit implementation of the camera (such as a netlist of engine 26), and the design process is thus complete.

Optionally, after prototypes of optics 22 have been fabricated, the DCF tables may be tested and modified in a testbench calibration procedure. Such a procedure may be desirable in order to correct the DCF for deviations between the actual performance of the optics and the simulated performance that was used in the design process of FIG. 4. A calibration procedure that may be used for this purpose is described in the above-mentioned provisional application.

Although the embodiments described above refer to certain specific digital filters, and particularly to a deconvolution filter (DCF), the principles of the present invention may similarly be applied in electronic cameras that use other types of digital image filters, as are known in the art. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for producing a camera, which includes objective optics for forming an image on an electronic image sensor and a digital filter for filtering an output of the image sensor, the method comprising:
defining a maximum permissible value of a noise gain;
determining one or more aberrations due to the objective optics;
calculating coefficients of the digital filter so as to compensate for the one or more aberrations while preventing the noise gain of the digital filter from exceeding the maximum permissible value; and
filtering the output of the image sensor using the computed coefficients so as to generate an enhanced output image.

2. The method according to claim 1, wherein determining the one or more aberrations comprises computing a point spread function (PSF) of the objective optics.

3. The method according to claim 2, wherein calculating the coefficients comprises computing a kernel of a deconvolution filter (DCF) responsively to the PSF.

4. The method according to claim 1, wherein defining the maximum permissible value of the noise gain comprises determining the maximum permissible value responsively to a noise characteristic of the image sensor.

5. The method according to claim 1, wherein filtering the output comprises smoothing the output, and wherein defining the maximum permissible value of the noise gain comprises determining the maximum permissible value subject to the smoothing.

6. The method according to claim 5, wherein smoothing the output comprises identifying edges in the output image, and applying a low-pass filter to areas of the output image other than the edges.

7. The method according to claim 1, wherein calculating the coefficients comprises estimating a modulation transfer function (MTF) of the objective optics responsively to the noise gain, and determining the coefficients so as to enhance the MTF.

8. A computer software product for producing a camera, which includes objective optics for forming an image on an electronic image sensor and a digital filter for filtering an output of the image sensor, the product comprising a computer-readable medium in which program instructions are stored, which instructions, when read by a computer, cause the computer to receive a definition of a maximum permissible value of a noise gain and an indication of one or more aberrations due to the objective optics, and to calculate coefficients of the digital filter so as to compensate for the one or more aberrations while preventing the noise gain of the digital filter from exceeding the maximum permissible value.

9. The product according to claim 8, wherein the indication of the one or more aberrations comprises a definition of point spread function (PSF) of the objective optics.

10. The product according to claim 9, wherein the instructions cause the computer to compute a kernel of a deconvolution filter (DCF) responsively to the PSF.

11. The product according to claim 8, wherein the maximum permissible value of the noise gain is determined responsively to a noise characteristic of the image sensor.

12. The product according to claim 8, wherein filtering the output comprises smoothing the output, and wherein the maximum permissible value of the noise gain is determined subject to the smoothing.

13. The product according to claim 12, wherein smoothing the output comprises identifying edges in the output image, and applying a low-pass filter to areas of the output image other than the widened edges.

14. The product according to claim 8, wherein the instructions cause the computer to estimate a modulation transfer function (MTF) of the objective optics responsively to the noise gain, and to determine the coefficients so as to enhance the MTF.

15. Apparatus for producing a camera, which includes objective optics for forming an image on an electronic image sensor and a digital filter for filtering an output of the image sensor, the apparatus comprising:
means for defining a maximum permissible value of a noise gain;
means for determining one or more aberrations due to the objective optics; and
means for calculating coefficients of the digital filter so as to compensate for the one or more aberrations while preventing the noise gain of the digital filter from exceeding the maximum permissible value.

16. The apparatus according to claim 15, wherein the indication of the one or more aberrations comprises a definition of point spread function (PSF) of the objective optics.

17. The apparatus according to claim 16, wherein the coefficients of the digital filter constitute a kernel of a deconvolution filter (DCF), which is computed responsively to the PSF.

18. The apparatus according to claim 15, wherein the maximum permissible value of the noise gain is determined responsively to a noise characteristic of the image sensor.

19. The apparatus according to claim 15, wherein filtering the output comprises smoothing the output, and wherein the maximum permissible value of the noise gain is determined subject to the smoothing.

20. The apparatus according to claim 19, wherein smoothing the output comprises identifying edges in the output image, and applying a low-pass filter to areas of the output image other than the widened edges.

21. The apparatus according to claim 15, wherein the means for calculating the coefficients comprise means for estimating a modulation transfer function (MTF) of the objective optics responsively to the noise gain, and determining the coefficients so as to enhance the MTF.

22. An electronic imaging camera, comprising:
an electronic image sensor;
objective optics for forming an image on an electronic image sensor; and
a digital filter for filtering an output of the image sensor,
wherein coefficients of the digital filter are calculated responsively to a maximum permissible value of a noise gain so as to compensate for one or more aberrations of the objective optics while preventing the noise gain of the digital filter from exceeding the maximum permissible value.
